(19) United States
(12) Patent Application Publication
(10) Pub. No.: US 2014/0039983 A1
(43) Pub. Date: Feb. 6, 2014

(54) LOCATION EVALUATION

(71) Applicants: Thomas C. Vinson, Manchester (GB); Andrew Lundquist, Manchester (GB)

(72) Inventors: Thomas C. Vinson, Manchester (GB); Andrew Lundquist, Manchester (GB)

(73) Assignee: KNOWLEDGE SUPPORT SYSTEMS LTD., Manchester (GB)

(21) Appl. No.: 13/566,362

(22) Filed: Aug. 3, 2012

(51) Int. Cl. G06Q 10/06

(52) U.S. Cl. 705/7.36

(57) ABSTRACT

Computer-implemented methods of generating values for a location, the value being associated with a use of the location, are provided. The methods comprise receiving data associated with said location, said data indicating properties of said location, receiving data associated with a plurality of training locations, and processing said data to generate ranking data. The value for the location is generated based upon the ranking data.

### TECHNICAL FIELD

The present invention relates to evaluation of locations.

### BACKGROUND OF THE INVENTION

In many industries, data associated with a particular location is useful in decision making processes. For example, retailers and other consumer-based businesses often determine as much information as possible on potential locations for a new retail site when making decisions on where to locate new facilities in order to try to identify potential locations with the greatest sales potential for new sites.

### SUMMARY OF THE INVENTION

However there is a need for improved methods for using available data associated with a particular location in decision making processes.

It is an object of the invention to provide improvements in systems and methods for using data associated with locations in decision making processes.

According to a first aspect of the invention there is provided a computer-implemented method of generating a value for a location, the value being associated with a use of the location, the method being implemented in a computer comprising a memory in communication with a processor. The method comprises receiving, as input to the processor, data associated with the location, the data indicating properties of the location and receiving, as input to the processor, data associated with a plurality of training locations. The data associated with the location and the data associated with the plurality of training locations is processed by the processor to generate a rank for the location relative to the plurality of training locations and the value for the location is generated by the processor based upon the generated rank and the data associated with the plurality of training locations.

Generating a value for a location based upon a generated rank for the location relative to a plurality of training locations and data associated with the plurality of training locations has been found to provide improved generation of values for locations.

The data associated with the location and the training locations may be based upon known properties of the location and the value may be a value for which it is desirable to determine an estimate for the location. For example, the location may be a proposed retail fuel site for which it is desirable to estimate expected fuel sales and the training locations may be existing retail fuel sites. The data associated with the locations may indicate properties relating to population and traffic for the location that is known for the location and each of the training locations. The data can be used to rank the location and the training locations relative to one another and the estimate for the location can be determined based upon the data associated with the plurality of training locations.

Processing the data associated with the location and the data associated with the plurality of training locations to generate a rank for the location may comprise generating, by the processor, a rank for each of the training locations and the location.

The data associated with the plurality of training locations may comprise a score for each of the training locations and the rank for the location may be based upon the scores and a score associated with the location. The score associated with the location may be based upon the data associated with the location.

The method may further comprise generating, by the processor, the score for the location, the score for the location being generated based upon a weighted combination of the data associated with the location. For example, the score may be determined by a weighted sum of the known data associated with the location.

The weights for the weighted combination may be generated based upon the training data associated with the plurality of training locations. For example, the weights may be determined based upon a linear regression of known values for the training locations, corresponding to the value to be determined for the location, and other data associated with the training locations that is also known for the location. Alternatively a Pearson correlation may be used to determine the weights.

The method may further comprise generating, by the processor, the score for each of the training locations. The score for each of the training locations is typically generated in the same way as for the location.

The training data may comprise a plurality of training values, each of the plurality of training values being associated with a respective one of the training locations, the training values corresponding to the value to be determined for the location and the value for the location may be generated based upon ranks associated with the training locations and the plurality of training values. That is, each of the plurality of training locations may have an associated rank relative to the location and one another and those ranks may be used in the determined of the value for the location.

Generating the value for the location based upon the generated rank may comprise processing, by the processor, the plurality of training values to determine an average training value, processing, by the processor, the ranking to generate an average ranking for the training locations and generating, by the processor, the value for the location based upon the average training value, an average rank associated with the training locations and the rank associated with the location. The ranks associated with the training locations may be scaled. Scaling can provide improved granularity for the value determined for the location.

The average rank for the training locations may be based upon ranks associated with a subset of said training locations. For example, the average rank may be based upon m closest ranks to the rank of the location, for example the m/2 closest ranks above the rank of the training location and the m/2 closest ranks below the rank of the training location.

Generating the value for the location based upon the generated rank may comprise processing, by the processor, the plurality of training values to determine an average training value, processing, by the processor, the plurality of training values and the ranks to determine an offset; and generating, by the processor, the value for the location based upon the average training value and the offset. In this way, it has been found that a more accurate estimate of a value can be determined for the location based upon the training site data.

Processing the plurality of training values and the ranking to determine an offset may comprise processing, by the processor, the ranking to determine an average rank for the training locations; determining, by the processor, a rank offset based upon a difference between the average rank and a rank associated with the location; determining, by the processor, a range of training values; determining, by the processor, a range of rank values associated with the training locations; and processing, by the processor, the rank offset, the range of training values and the range of rank values to determine said offset.

According to a second aspect of the invention there is provided a computer-implemented method of generating a value for a location, the value being associated with a use of the location, the method being implemented in a computer comprising a memory in communication with a processor. The method comprises receiving, as input to the processor, data associated with the location, the data indicating properties of the location; receiving, as input to the processor, training data associated with a plurality of training locations, the data indicating properties of the training locations; processing, by the processor, a plurality of subsets of the training data to generate rank data associated with the training locations, the rank data comprising a respective rank associated with each of the plurality of subsets; processing, by the processor, the rank data associated with the training locations to generate coefficient data, the coefficient data comprising a respective coefficient associated with each of the plurality of subsets; and generating, by the processor, the value for the location based upon the data associated with the location and the coefficient data.

The subsets of the training data can be used to group together related properties of the training locations and those related properties are processed individually to generate rank data. By processing the training data based upon a plurality of subsets of the training data to generate rank data associated with the training locations and generating coefficients for the plurality of subsets it has been found that values for locations that more accurately estimate a property of the location can be determined. In particular, it has been found that the coefficients that are generated based upon grouped related properties can be used to provide an improved model for estimation of values for locations.

The training data may comprise a plurality of properties, each property having an associated value for each of the training locations, and each of the plurality of subsets of the training data may have at least one associated property of the plurality of properties and may comprise only values of the at least one associated property. For example, each training location may have three associated data items relating to population for the location and two data items relating to traffic for the location. One of the subsets may include the three data items relating to population for each of the training locations. and another of the subsets may include the two data items relating to traffic for each of the training locations.

Processing the rank data associated with the training locations to generate coefficient data may comprise performing, by the processor, a regression process on said rank data associated with said training locations. The regression process may be, for example, a linear regression.

The regression process may be bounded. For example, the regression process may require that a positive coefficient is determined for each of the subsets.

Processing the plurality of subsets of the training data to generate rank data associated with the training locations may comprise, for each of the plurality of subsets of the training data: generating, by the processor, a score associated with each of the training locations based upon the subset of the training data; and generating, by the processor, a rank of the rank data for each of the training locations. The rank data therefore comprises a rank for each of the training locations is therefore generated for each of the plurality of subsets.

The score for the location may be generated based upon a weighted combination of the subset of the training data associated with said location. For example, the score may be determined by a weighted sum of the known data associated with the location.

The weights for the weighted combination may be generated based upon the training data associated with the plurality of training locations. For example, the weights may be determined based upon a linear regression of known values for the training locations, corresponding to the value to be determined for the location, and other data associated with the training locations that is also known for the location. Alternatively a Pearson correlation may be used to determine the weights.

The method may further comprise generating, by the processor, the score for each of the training locations. The score for each of the training locations is typically generated in the same way as for the location.

According to a third aspect of the invention there is provided a computer-implemented method of determining an effect of a first location on a second location, the method being implemented in a computer comprising a memory in communication with a processor. The method comprises receiving, as input to the processor, a first rank associated with the first location; receiving, as input to the processor, a second rank associated with the second location; and determining, by the processor, the effect of the first location on the second location based upon the first and second ranks.

The third aspect of the invention therefore provides a way of estimating the effect of a new location on an existing location. It has been found that by generating a rank for the locations and determining the effect based upon the associated ranks, an improved estimate can be generated.

It will be appreciated that aspects of the invention can be implemented in any convenient form. For example, the invention may be implemented by appropriate computer programs which may be carried on appropriate carrier media which may be tangible carrier media (e.g. disks) or intangible carrier media (e.g. communications signals). Aspects of the invention may also be implemented using suitable apparatus which may take the form of programmable computers running computer programs arranged to implement the invention.

### BRIEF DESCRIPTION OF THE DRAWINGS

Embodiments of the invention will now be described, by way of example, with reference to the accompanying drawings in which:

FIG. 1 is a schematic illustration of evaluation of a location;

FIG. 1A is a schematic illustration of a computer suitable for carrying out the invention;

FIG. 2 is a flowchart showing processing to rank training sites;

FIG. 3 is a flowchart showing processing to determine a value for a site; and

FIG. 4 is a flowchart showing alternative processing to determine a value for a site.

### DETAILED DESCRIPTION

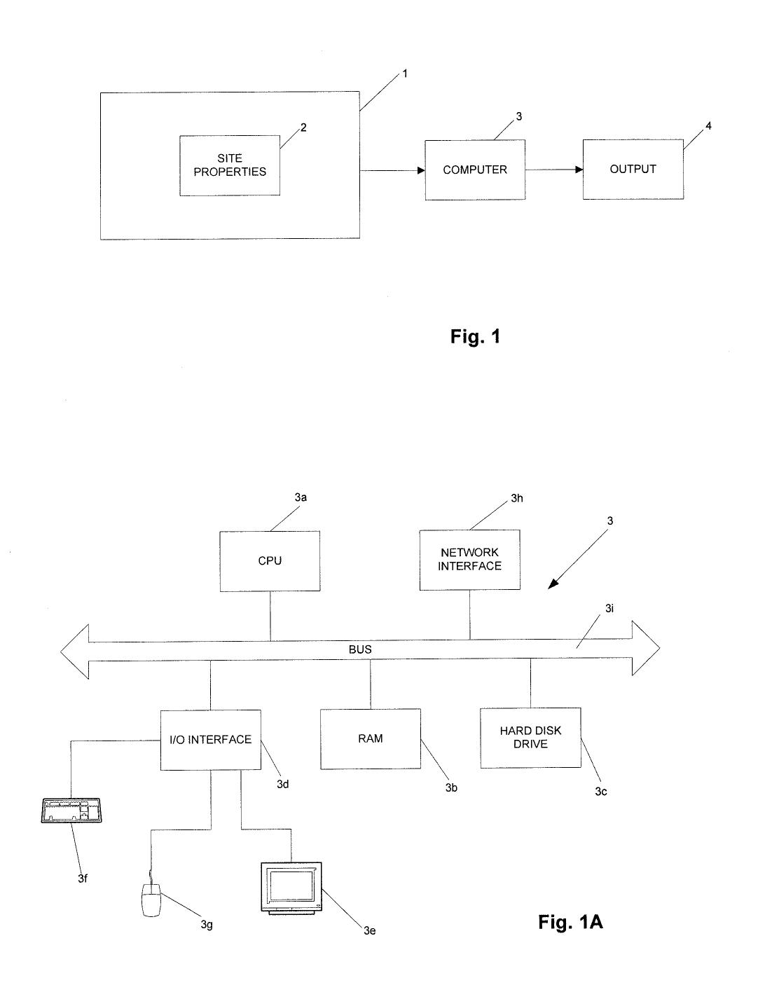

Referring first to FIG. 1, an evaluation site 1 has associated site properties 2 based upon a location of the evaluation site 1. A computer 3 is arranged to receive the site properties 2 and to generate output 4 providing an indication of a property of the evaluation site 1. For example, evaluation site 1 may be a site for a new retail fuel store and the output 4 may provide an estimate of sales at the new retail fuel store based upon site properties for the evaluation site 1 that are relevant to sales at a retail fuel store such as location population data, location type, fuel brand and retail fuel store facilities together with data associated with competitor site sales and the relationship between the competitor site sales and sales of the evaluation site 1.

FIG. 1A shows the computer 3 in further detail. It can be seen that the computer comprises a CPU 3a which is configured to read and execute instructions stored in a volatile memory 3b which takes the form of a random access memory. The volatile memory 3b stores instructions for execution by the CPU 3a and data used by those instructions. For example, in use, data associated with the site properties 2 may be stored in the volatile memory 3b.

The computer 3 further comprises non-volatile storage in the form of a hard disc drive 3c (e.g., for storage on a generally permanent basis) or another non-transitory computer readable medium such as another memory or a disc. Data associated with the site properties 2 may be stored on the hard disc drive 3c. The computer 3 further comprises an I/O interface 3d to which are connected peripheral devices used in connection with the computer 3. More particularly, a display 3e is configured so as to display output from the computer 3. The display 3e may, for example, display a representation of the output 4. Input devices are also connected to the I/O interface 3d. Such input devices include a keyboard 3f and a mouse 3g which allow user interaction with the computer 3. A network interface 3h allows the computer 3 to be connected to an appropriate computer network so as to receive and transmit data from and to other computing devices. The CPU 3a, volatile memory 3b, hard disc drive 3c, I/O interface 3d, and network interface 3h, are connected together by a bus 3i.

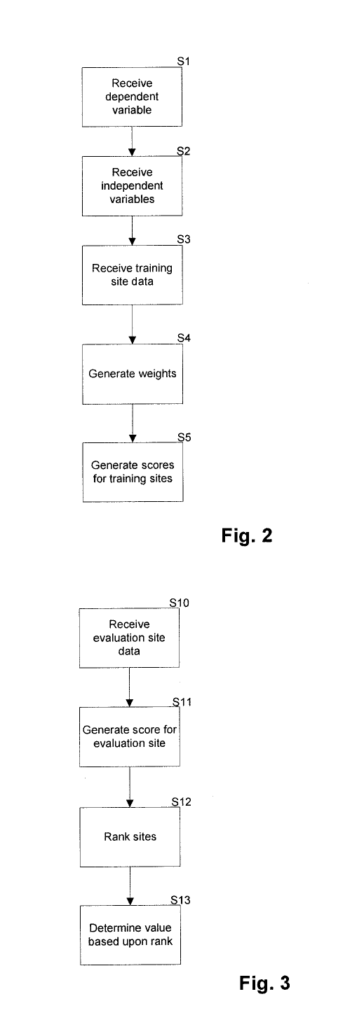

Referring now to FIG. 2, processing to rank a plurality of training sites is shown. The training sites are sites that are currently used in the way that it is desirable to use the evaluation site 1 and for which data is available. For example, it may be desirable to evaluate the suitability of the evaluation site for locating a retail fuel store and the training sites are therefore locations having an existing retail fuel store and for which data suitable for evaluating retail fuel stores is available, for example fuel sales data and associated demographic and location data.

In more detail, at step S1 an indication of a dependent variable y upon which it is desirable to evaluate sites is received. For example, where the evaluation sites are retail fuel stores the dependent variable y will typically be associated with fuel sales, for example volume sales or sales revenue. At step S2 an indication of n independent variables xⱼ are received. The independent variables xⱼ are each associated with data that affects the dependent variable. For example, where the evaluation sites are retail fuel stores the independent variables will typically be associated with data such as population and traffic. Selection of the independent variables is described in further detail below.

At step S3 training site data indicating values for each of the independent variables and the dependent variable for each of k training sites is received. The training site data may be obtained in any convenient way, for example, where the independent variables includes population data the data may be based upon publically available data such as demographic data available from Easy Analytic Software, Inc. (www.easidemographics.com) and/or traffic count data that is generally publically available from State, County, City and regional planning organizations. The training data may be normalized before further processing described below, for example based upon the mean and standard deviation of the training data.

At step S4 a weight wⱼ is generated for each of the independent variables by processing the training site data. The weights may be generated in any convenient way, for example using linear regression of the dependent variable against the sum of the independent variables for each training site, for example using least squares fitting.

Alternatively weights may be generated based upon the Pearson correlation between each independent variable and the dependent variable. For example the Pearson correlation for each independent variable and the dependent variable may first be determined and normalized, for example by processing the determined Pearson correlations such that the absolute values of the Pearson correlations sum to 100, to generate a value corrⱼ. A value sigⱼ indicating the statistical significance of the independent variable xⱼ and the dependent variable is also determined for each independent variable and the weights wⱼ are determined according to equation (1) below. For example, the value sigⱼ may be the p-value of the independent variable xⱼ and the dependent variable from a two-sided t-test.

wⱼ=corrⱼ(1−sigⱼ) (1)

At step S5 a value score, is determined for each training site 1≦i≦k based upon the weights wⱼ and values associated with the training sites i for the independent variables xᵢⱼ according to equation (2).

$${score}_{i} = {\sum }_{j = 1}^{n} {x}_{ij} {w}_{j} \qquad ( 2 )$$

The scores determined at step S5 for the training sites are used to determine a value for the dependent variable for evaluation site 1, as will now be described with reference to FIG. 3. At step S10 data associated with the evaluation site is received. The data associated with the evaluation site provides a value for each of the independent variables xⱼ. At step S11 a score is generated for the evaluation site based upon the data received at step S10. The score is generated according to equation (2) in the same manner as for the training sites.

At step S12 the training sites and the evaluation site are each assigned a rank based upon the values scoreᵢ generated at steps S5 and S11. The ranks may be scaled based upon a user input maximum ranking maxᵣₐₙₖ and a user input minimum ranking minᵣₐₙₖ and the maximum value max(scoreᵢ) 1≦i≦k and minimum value min(scoreᵢ), 1≦i≦k. The range of the user input rankings is determined by calculating the value user_{range}=maxᵣₐₙₖ−minᵣₐₙₖ and the range of the values scoreᵢ is determined by calculating the value score_{range}=max(scoreᵢ)−min(scoreᵢ). A ratio of the user input range to the score range may then be determined by calculating the value ratio_{range=user}_{range}/score_{range} and the scaled rank for each site i, scaledrankᵢ, may be determined as scaledrankᵢ=(scoreᵢ−min(scoreᵢ))*ratio_{range}.

At step S13 a value for the dependent variable is generated for the evaluation site based upon training site values for dependent variables and associated ranks and the rank for the evaluation site. For example, the value for the dependent variable may be determined based upon training sites having ranks closest to the rank of the evaluation site by determining an average dependent variable value per rank according to (3):

$${y}_{eval} = \frac{{y}_{average}}{{rank}_{average}} * {rank}_{eval} \qquad ( 3 )$$

where:

yₑᵥₐₗ is the generated dependent variable value for the evaluation site;

y_{average} is the average dependent variable value for the m training sites having rank directly above the evaluation site and m training sites ranking directly below the evaluation site, where m is a predetermined number, for example 3;

rank_{average} is the (possibly scaled) average rank for the m training sites used in the determination of y_{average}, and

rankₑᵥₐₗ is the (possibly scaled) rank of the evaluation site.

Alternatively, in some embodiments the average values may be calculated based upon all training sites.

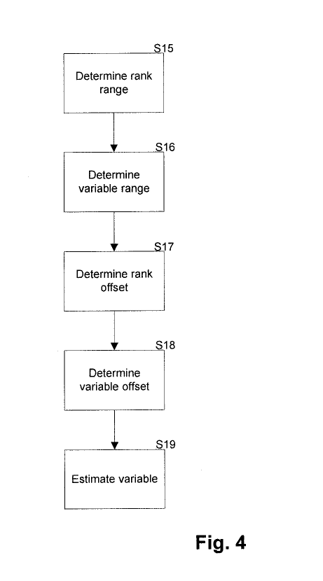

Alternatively the value for the dependent variable may be determined for the evaluation site by interpolating between m training sites having rank directly above and below as will now be described with reference to FIG. 4. At step S15 a rank range rankrange is determined according to (4):

rankRange=rankAv_{above}−rankAv_{below} (4)

where:

rankAv_{above} is the average rank of the m training sites ranking directly above the evaluation site;

rankAv_{below} is the average rank of the m training sites ranking directly below the evaluation site; and

m is a predetermined number as before.

At step S16 a dependent variable range yRange is determined in a corresponding manner to the rank range according to (5):

yRange=yAv_{above}−yAv_{below} (5)

where:

yAv_{above} is the average dependent variable value of the m training sites used in the determination of the value rankRange; and

yAv_{below} is the average dependent variable value of the m training sites used in the determination of the value rankRange.

At step S17 a rank offset indicating a difference between the rank of the evaluation site and the training sites is determined according to (6),

rankOffset=rankₑᵥₐₗ−rankAv_{below} (6)

and at step S18 a variable offset is determined according to (7).

$$yOffset = \frac{rankOffset}{rankRange} * yRange \qquad ( 7 )$$

At step S19 an estimated value for the dependent variable for the evaluation site yₑᵥₐₗ is generated according to (8).

yₑᵥₐₗ=yOffset+(yAv_{below}) (8)

The way in which the estimated value is calculated may be selected for example by processing a training set of evaluation sites for which values are known to determine a calculation method for yₑᵥₐₗ that provides estimated values that are closest to the known values.

In some embodiments the dependent variables may be grouped into p categories category₁, . . . , categoryₚ of related factors associated with independent variables. For example factors relating to population demographic may be grouped and factors relating to features of the site may be grouped.

A value for each category of each training site can be generated by summing the independent variables associated with each category for each training site such that for each training site i 1≦i≦k values category₁(1), categoryₚ(k) are generated. Each category is processed according to FIG. 2 to generate a rank for each training site and category such that p ranks are generated for each training site. That is, for each training site values rank(category₁), . . . , rank(category₂) are generated.

The ranks for each category of each training site are determined, for example, by excluding all independent variables other than the independent variables for the particular category from each training site and ranking the training sites using the processing of FIG. 2 based upon only the independent variables for the particular category.

That is, to determine a rank for a category categoryₘ, 1≦m≦p, at step S4 of FIG. 2 a weight wᵢ is generated for each independent variable associated with categoryₘ by processing the training site data associated with the independent variables associated with categoryₘ only and at step S5 a value score, is generated for each training site based upon weighted values for the independent variables associated with categoryₘ. The values score, are used to rank the training sites and the rank associated with each training site i is assigned to categoryₘ for the training site i. The process is repeated until each of the p categories has been processed to determine respective ranks for the training sites for that category.

A log-linear regression may then be performed on the plurality of categories and generated ranks to generate coefficients associated with each of the categories. The coefficients may be bounded such that the influence of each category on the value can be constrained within a predetermined range. For example, the bounds may be approximately 0.01 and approximately 0.99 such that each category has a non-zero influence, and at least two categories have an influence, that is, no single category is the sole influence. The regression model for the log-linear regression has the general form (9):

log(y)˜intercept+coef₁(log(rank(category₁)))+ . . . +coefₚ(log(rank(categoryₚ))) (9)

where:

log(y) is a vector of log(y) values, with each element of the vector indicating the log of the value y for a corresponding training site;

log(rank(category₁)), . . . log(rank(categoryₚ)) each being a vector of log(rank(category)) values, which each element of each vector indicating the log of the rank of the associated category for a corresponding training site; and

the values intercept, coef₁, . . . , coefₚ are output from the log-linear regression with the values coef₁, . . . , coefₚ providing weights for the influence of each of the categories and the value intercept providing an offset.

A value yₑᵥₐₗ can be determined for a site to be evaluated based upon the values intercept, coef₁, . . . , coefₚ generated by the log-linear regression based upon (9) and values for each category for the evaluation site according to (10):

e^{log(y}^{ₑᵥₐₗ}) (10)

where log(yₑᵥₐₗ) is determined according to (11).

log(yₑᵥₐₗ)=intercept+coef₁log(category₁)+ . . . +coefₚlog(categoryₚ) (11)

It is indicated above that independent variables are received upon which determination of the dependent variable is to be based. The independent variables are selected by determining factors that affect the dependent variable and may be determined by using different sets of independent variables to generate estimates for dependent variables for sites for which the value of the dependent variable is known but that are not included in the training set. In this way, the effect of the different independent variables upon the quality of the value generated for the dependent variable can be determined.

The ranks determined as described above may be used to determine an effect that creation of an evaluation site will have upon competitor sites in the area. Such an effect can be useful in an evaluation of a site, for example where a network of retail fuel sites are owned by a single entity in which case other sites owned by the entity are considered as competitor sites for the purposes of volume sales. In such a case the overall effect of the creation of a new site on the network of retail fuel sites can be determined, including both the positive effect of the evaluation site on total sales and any negative effect of the evaluation site at existing sites in the network of retail fuel sites. The effect that creation of an evaluation site has on an existing site may be determined according to (12):

$$change = \frac{1}{{e}^{distance * decay * {ratio}_{rank}}} \qquad ( 12 )$$

where:

distance is determined based upon the straight-line distance between the evaluation site and can be determined based upon the longitude and latitude of the evaluation site and the competitor site;

decay is a constant determined based upon analysis of historical data; and

the value ratioᵣₐₙₖ is a ratio of the ranks of the existing site to the evaluation site and is determined according to (13) below.

$${ratio}_{rank} = \frac{{rank}_{existing}}{{rank}_{eval}} \qquad ( 13 )$$

In some embodiments it is assumed that the total value across all competing locations does not change. For example, where the sites are retail fuel sites the total volume sales in an area typically does not increase with the construction of a new retail fuel site, and rather the original volume sales in the area is redistributed across the sites in the area. Where it is assumed that the total value does not change the value determined for each location may be scaled by a scaling factor sf determined according to (14):

$$sf = \frac{sum ( {y}_{original} )}{sum ( {y}_{eval} )} \qquad ( 14 )$$

where:

sum(y_{original}) indicates the total value for all sites before estimated modification due to the evaluation site; and

sum(yₑᵥₐₗ) indicates the total value for all sites after modification. Scaling each value yₑᵥₐₗ according to the scaling factor sf therefore results in the total remaining unchanged.

Although specific embodiments of the invention have been described above, it will be appreciated that various modifications can be made to the described embodiments without departing from the spirit and scope of the present invention. That is, the described embodiments are to be considered in all respects exemplary and non-limiting. In particular, where a particular form has been described for particular processing, it will be appreciated that such processing may be carried out in any suitable form arranged to provide suitable output data.

What is claimed is:

1. A computer-implemented method of generating a value for a location, the value being associated with a use of said location, the method being implemented in a computer comprising a memory in communication with a processor, the method comprising:
receiving, as input to the processor, data associated with said location, said data indicating properties of said location;
receiving, as input to the processor, data associated with a plurality of training locations;
processing, by the processor, said data associated with said location and said data associated with said plurality of training locations to generate a rank for said location relative to said plurality of training locations; and
generating, by the processor, said value for said location based upon said generated rank and said data associated with said plurality of training locations.

2. The computer-implemented method according to claim 1, wherein processing said data associated with said location and said data associated with said plurality of training locations to generate a rank for said location comprises:
generating, by the processor, a rank for each of said training locations and said location.

3. The computer-implemented method according to claim 1, wherein said data associated with a plurality of training locations comprises a score for each of said training locations, wherein said rank for said location is based upon said scores and a score associated with said location, said score being based upon said data associated with said location.

4. The computer-implemented method according to claim 3, further comprising:
generating, by the processor, said score for said location, said score for said location being generated based upon a weighted combination of said data associated with said location.

5. The computer-implemented method according to claim 4, wherein said weights for said weighted combination are generated based upon said training data associated with said plurality of training locations.

6. The computer-implemented method according to claim 3, further comprising generating, by the processor, said score for each of said training locations.

7. The computer-implemented method according to claim 2, wherein said training data comprises a plurality of training values, each of said plurality of training values being associated with a respective one of said training locations;
wherein said value for said location is generated based upon respective ranks associated with said training locations and said plurality of training values.

8. The computer-implemented method according to claim 7, wherein generating said value for said location based upon said generated rank comprises:
processing, by the processor, said plurality of training values to determine an average training value;
processing, by the processor, said ranks associated with said training locations to generate an average rank for said training locations; and
generating, by the processor, said value for said location based upon said average training value, said average rank and a rank associated with said location.

9. The computer-implemented method according to claim 8, wherein said average rank for said training locations is based upon ranks associated with a subset of said training locations.

10. The computer-implemented method according to claim 7, wherein generating said value for said location based upon said generated rank comprises:
processing, by the processor, said plurality of training values to determine an average training value;
processing, by the processor, said plurality of training values and said ranks associated with said training locations to determine an offset; and
generating, by the processor, said value for said location based upon said average training value and said offset.

11. The computer-implemented method according to claim 10, wherein processing said plurality of training values and said ranks associated with said training locations to determine an offset comprises:
processing, by the processor, said ranks to determine an average rank for said training locations;
determining, by the processor, a rank offset based upon a difference between said average rank and a rank associated with said location;
determining, by the processor, a range of training values;
determining, by the processor, a range of rank values associated with said training locations; and
processing, by the processor, said rank offset, said range of training values and said range of rank values to determine said offset.

12. A computer readable medium carrying a computer program comprising computer readable instructions configured to cause a computer to carry out a method according to claim 1.

13. A computer apparatus for generating a value for a location, the value being associated with a use of said location, the apparatus comprising:
a memory storing processor readable instructions; and
a processor arranged to read and execute instructions stored in said memory;
wherein said processor readable instructions comprise instructions arranged to control the computer to carry out a method according to claim 1.

14. A computer-implemented method of generating a value for a location, the value being associated with a use of said location, the method being implemented in a computer comprising a memory in communication with a processor, the method comprising:
receiving, as input to the processor, data associated with said location, said data indicating properties of said location;
receiving, as input to the processor, training data associated with a plurality of training locations, said data indicating properties of said training locations;
processing, by the processor, a plurality of subsets of said training data to generate rank data associated with said training locations, said rank data comprising a respective rank associated with each of said plurality of subsets;
processing, by the processor, said rank data associated with said training locations to generate coefficient data, said coefficient data comprising a respective coefficient associated with each of said plurality subsets; and
generating, by the processor, said value for said location based upon said data associated with said location and said coefficient data.

15. The computer-implemented method according to claim 14, wherein said training data comprises a plurality of properties, each property having an associated value for each of said training locations, wherein each of said plurality of subsets of said training data has at least one associated property of said plurality of properties and comprises only values of the at least one associated property.

16. The computer-implemented method according to claim 14, wherein processing said rank data associated with said training locations to generate coefficient data comprises:
performing, by the processor, a regression process on said rank data associated with said training locations.

17. The computer-implemented method according to claim 16, wherein said regression process is bounded.

18. The computer-implemented method according to claim 14, processing said plurality of subsets of said training data to generate rank data associated with said training locations comprises, for each of said plurality of subsets of said training data:
generating, by the processor, a score associated with each of said training locations based upon said subset of said training data; and
generating, by the processor, a rank of said rank data for each of said training locations.

19. The computer-implemented method according to claim 18, wherein said score for said location is generated based upon a weighted combination of said subset of said training data associated with said location.

20. The computer-implemented method according to claim 19, further comprising:
generating, by the processor, weights for said weighted combination based upon said training data associated with said plurality of training locations.

21. A computer readable medium carrying a computer program comprising computer readable instructions configured to cause a computer to carry out a method according to claim 14.

22. A computer apparatus for generating a value for a location, the value being associated with a use of said location, the apparatus comprising:
a memory storing processor readable instructions; and
a processor arranged to read and execute instructions stored in said memory;
wherein said processor readable instructions comprise instructions arranged to control the computer to carry out a method according to claim 14.

23. A computer-implemented method of determining an effect of a first location on a second location, the method being implemented in a computer comprising a memory in communication with a processor, the method comprising:
receiving, as input to the processor, a first rank associated with said first location;
receiving, as input to the processor, a second rank associated with said second location; and
determining, by the processor, said effect of said first location on said second location based upon said first and second ranks.

24. A computer readable medium carrying a computer program comprising computer readable instructions configured to cause a computer to carry out a method according to claim 23.

25. A computer apparatus for determining an effect of a first location on a second location, the apparatus comprising:
a memory storing processor readable instructions; and
a processor arranged to read and execute instructions stored in said memory;
wherein said processor readable instructions comprise instructions arranged to control the computer to carry out a method according to claim 23.
